(19) United States
(12) Patent Application Publication
(10) Pub. No.: US 2024/0000082 A1
(43) Pub. Date: Jan. 4, 2024

(54) A SEED SURFACE COMPOSITION COMPRISING A DPP PIGMENT AND A SEED TREATED WITH SAID COMPOSITION

(71) Applicant: SUN CHEMICAL B.V., Weesp (NL)

(72) Inventors: Christian FABIAN, Ludwigshafen am Rhein (DE); Arno TUCHBREITER, Southfield, MI (US); Maria Ligia ROES, Ludwigshafen am Rhein (DE)

(73) Assignee: SUN CHEMICAL B.V., Weesp (NL)

(21) Appl. No.: 18/254,421

(22) PCT Filed: Dec. 2, 2021
(86) PCT No.: PCT/EP2021/083983

§ 371 Date: May 25, 2023

(30) Foreign Application Priority Data
Dec. 3, 2020 (EP) 20211513.5

(51) Int. Cl. A01N 43/90; A01N 25/26; A01C 1/06

(52) U.S. Cl. CPC A01N 43/90; A01N 25/26; A01C 1/06

(57) ABSTRACT

The present invention relates to a seed surface composition including a compound according to formula (I)

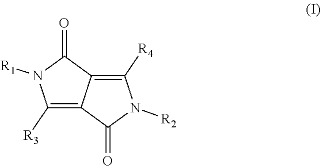

wherein R1 and R2 are independently of one another hydrogen, C1-C4 alkyl, halogenated C1-C4 alkyl, C1-C4 acetyl; and R3 and R4 are independently of one another phenyl, C1-C5 alkylphenyl, C1-C5 alkoxyphenyl, halogenated phenyl, cyanophenyl, biphenyl, halogenated biphenyl, pyridyl, C1-C5 alkylpyridyl, C1-C5 alkoxypyridyl, halogenated pyridyl or naphthyl. The present invention further relates to a seed treated with a composition including a compound according to formula (I). The present invention furthermore relates to a process for producing the seed surface composition. The present invention furthermore relates the use of a compound according to formula (I) in a seed surface composition.

### TECHNICAL FIELD

The present invention relates to a seed surface composition comprising a compound according to formula (I)

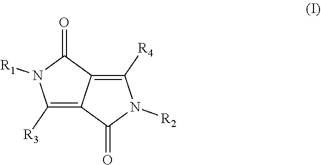

wherein R₁ and R₂ are independently of one another hydrogen, C₁-C₄ alkyl, halogenated C₁-C₄ alkyl, C₁-C₄ acetyl; and R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl. The present invention further relates to a seed treated with a composition comprising a compound according to formula (I). The present invention furthermore relates to a process for producing the seed surface composition. The present invention furthermore relates the use of a compound according to formula (I) in a seed surface composition.

### INTRODUCTION

It has been known to apply various active ingredients directly to the surface of seeds for protecting the seeds from disease, fungi and insects, etc., and for the purpose of providing the seed with growth regulators and nutrients. Seeds treated on the surface with active ingredients have proven to be quite successful in terms of germination rates, etc. Seeds treated on the surface for the above-mentioned purposes are not intended for the use as food or feed. To avoid that these seeds get into the food chain, these seeds have to be marked by a color. In many cases, e.g. cereal seeds or seeds for maize or other food and feed crops are marked using a red colorant. For this purpose widely used red pigments are based on diazo-chemistry, e.g. C.I. PR 112, PR 48:2, PR 53:1 (D&C Red No. 9), PR 57:1 (D&C Red No. 6) or PR 57:2 (D&C Red No. 7). Diazo pigments have disadvantages regarding ecological effects due to the reductive cleavage of the azo bonds or hydrolysis of anilido bonds, which would produce aromatic amines, many of which have been under global scrutiny due to a suspicion for genotoxicity or carcinogenicity. They are regulated in several countries and particularly for applications with food contact. So for example, commonly used C.I. PR 112 could possibly release 2,4,5-trichloraniline, which has to be considered as toxic in contact with skin, toxic if inhaled and is very toxic to aquatic life. Other typical diazo colorants used may potentially degrade to sulfonated aromatic amines that are not genotoxic, but are water soluble.

Accordingly, there remains the problem of providing a seed surface composition and treated seeds, which do not contain diazo compounds, but are highly versatile with regard to the amount of the used color and obtained color depth. In particular, there remains the problem of providing a seed surface composition and treated seeds, which do not have disadvantages regarding ecological effects and are highly versatile with regard to the amount of the compound according to formula (I) used while having the required color depth.

### DETAILED DESCRIPTION

It was therefore an object of the present invention to provide an improved seed surface composition comprising a compound according to formula (I)

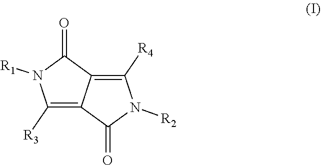

wherein R₁ and R₂ are independently of one another hydrogen, C₁-C₄ alkyl, halogenated C₁-C₄ alkyl, C₁-C₄ acetyl; and R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl, which do not contain diazo compounds. Thus, it was surprisingly found that a seed surface composition and a seed treated with said composition comprising a compound according to formula (I) has an improved hiding power and provide uniform coloration of the surface of the seed when compared with compositions containing red pigments that comprise diazo compounds. Further, it was surprisingly found that the seed surface composition comprising a half load of a compound according to formula (I), provides similar or better color depth when compared to a composition containing a double load of a diazo compound. Furthermore, the seed surface composition with higher concentration of a compound according to formula (I) can be obtained, which in turn dry faster when applied on the surface of the seed.

Therefore, the present invention relates to a seed surface composition comprising a compound according to formula (I)

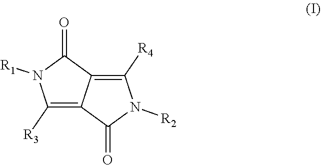

wherein R₁ and R₂ may, independently of one another, stand for hydrogen, C₁-C₄ alkyl, halogenated C₁-C₄ alkyl, C₁-C₄ acetyl; and R₃ and R₄ may, independently of one another, stand for phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

According to the present invention, it is preferred that said seed is an embryonic plant enclosed in a protective outer covering, wherein preferably said seed is selected from the group consisting of one or more of a plant, fruit or vegetable seed, more preferably said seed is selected from the group consisting of one or more of cereal seed, grass seed, vegetable seed, forage seed, legume seed, oil plant seed and a mixture of two or more thereof.

According to the present invention, it is preferred that R₁ and R₂ may, independently of one another, stand for hydrogen, C₁-C₄ alkyl; and R₃ and R₄ may, independently of one another, stand for phenyl, C₁-C₅ alkylphenyl, halogenated phenyl, cyanophenyl.

According to the present invention, it is preferred that R₁ and R₂ may, independently of one another, stand for hydrogen, C₁-C₄ alkyl; and R₃ and R₄ may, independently of one another, stand for phenyl, methylphenyl, 1,1-dimethylethyl phenyl, halogenated phenyl.

According to the present invention, it is preferred that R₁ is R₂ and R₃ is R₄.

According to the present invention, it is preferred that R₁ and R₂ are hydrogen; and R₃ and R₄ are halogenated phenyl.

According to the present invention, it is further preferred that R₁ and R₂ are hydrogen; and R₃ and R₄ are chlorophenyl.

According to the present invention, it is particularly preferred that R₁ and R₂ are hydrogen; and R₃ and R₄ are 4-chlorophenyl.

According to the present invention, it is particularly preferred that that in said composition diazo compounds, preferably 3-hydroxy-N-(2-methylphenyl)-4-[(2,4,5-trichlorophenyl)diazenyl]naphthalene-2-carboxamide, calcium 2-[(3-carboxy-2-oxidonaphthalen-1-yl)diazenyl]-4-chloro-5-methylbenzenesulfonate, disodium 2-[(3-carboxy-2-oxidonaphthalen-1-yl)diazenyl]-5-methylbenzenesulfonate, calcium 2-[(3-carboxy-2-oxidonaphthalen-1-yl)diazenyl]-5-methylbenzenesulfonate and 5-chloro-2-[(2-hydroxy-1-naphthalenyl)azo]-4-methyl benzene-sulfonic acid, barium salt (2:1) are excluded.

According to the present invention, it is preferred that the compound (1) is present in an amount in a range of from 1 to 20 weight-%, preferably in the range of from 2 to 15 weight-%, more preferably in the range of from 3 to 10 weight-%, more preferably in the range of from 4 to 8 weight-%, more preferably in the range of from 4 to 7.5 weight-%, based on the total weight of the seed surface composition.

According to the present invention, it is preferred that said seed surface composition further comprises a binder.

According to the present invention, it is preferred that the binder is selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, one or more gelatin, one or more lignosulfonates, and a mixture of two or more thereof, preferably selected from the group consisting of one or more polyvinyl acetate, one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

According to the present invention, it is preferred that the binder is present in the seed surface composition in an amount in the range of from 5 to 50 weight-%, preferably in the range of from 10 to 45 weight-%, more preferably in the range of from 10 to 40 weight-% based on the total weight of the seed surface composition.

According to the present invention, it is preferred that said seed surface composition further comprises water.

According to the present invention, it is preferred that the water is present in the seed surface composition in an amount in the range of from 40 to 85 weight-%, preferably in the range of from 45 to 80 weight-%, more preferably in the range of from 50 to 75 weight-% based on the total weight of the seed surface composition.

According to the present invention, it is preferred that said seed surface composition further comprises an inorganic pigment.

According to the present invention, it is particularly preferred that the inorganic pigment is selected from the group consisting of one or more titanium dioxide, one or more calcium carbonate, one or more iron oxide, one or more polygorskite ((Mg,Al)₂Si₄O₁₀(OH)·4(H₂O)), magnesium oxide, one or more clay and a mixture of two or more thereof, preferably the inorganic pigment is titanium dioxide.

According to the present invention, it is preferred that from 95 to 100 weight-%, preferably from 98 to 100 weight-%, more preferably from 99 to 100 weight-% of the composition consist of the compound of formula (I), the binder and the inorganic pigment.

The present invention further relates to a seed treated with a composition, said composition comprising a compound according to formula (I)

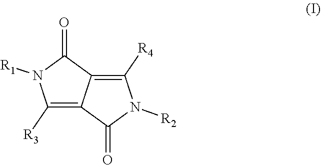

wherein R₁ and R₂ may, independently of one another, stand for hydrogen, C₁-C₄ alkyl, halogenated C₁-C₄ alkyl, C₁-C₄ acetyl; and R₃ and R₄ may, independently of one another stand for-phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

According to the present invention, it is preferred that said seed is an embryonic plant enclosed in a protective outer covering, wherein preferably said seed is selected from the group consisting of one or more of a plant, fruit or vegetable seed, more preferably said seed is selected from the group consisting of one or more of cereal seed, grass seed, vegetable seed, forage seed, legume seed, oil plant seed and a mixture of two or more thereof.

According to the present invention, it is preferred that in the inventive seed treated with a composition, R₁ and R₂ may, independently of one another, stand for hydrogen, C₁-C₄ alkyl; and R₃ and R₄ may, independently of one another stand for phenyl, C₁-C₅ alkyl phenyl, halogenated phenyl, cyanophenyl.

According to the present invention, it is preferred that in the inventive seed treated with a composition, R₁ and R₂ are hydrogen; and R₃ and R₄ may, independently of one another stand for phenyl, methylphenyl, 1,1-methylethylphenyl, halogenated phenyl.

According to the present invention it is further preferred that in the inventive seed treated with a composition, R₁ is R₂ and R₃ is R₄.

According to the present invention, it is preferred that in the inventive seed treated with a composition, R₁ and R₂ are hydrogen; and R₃ and R₄ are halogenated phenyl.

According to the present invention, it is preferred that in the inventive seed treated with a composition, R₁ and R₂ are hydrogen; and R₃ and R₄ are chlorophenyl.

According to the present invention, it is particularly preferred that in the inventive seed treated with a composition, R₁ and R₂ are hydrogen; and R₃ and R₄ are 4-chlorophenyl.

According to the present invention, it is preferred that that in the inventive seed treated with a composition diazo compounds, preferably 3-hydroxy-N-(2-methylphenyl)-4-[(2,4,5-trichlorophenyl)diazenyl]naphthalene-2-carboxamide, calcium 2-[(3-carboxy-2-oxidonaphthalen-1-yl)diazenyl]-4-chloro-5-methylbenzenesulfonate, disodium 2-[(3-carboxy-2-oxidonaphthalen-1-yl)diazenyl]-5-methylbenzenesulfonate, calcium 2-[(3-carboxy-2-oxidonaphthalen-1-yl)diazenyl]-5-methylbenzenesulfonate and 5-chloro-2-[(2-hydroxy-1-naphthalenyl)azo]-4-methyl benzene sulfonic acid, barium salt (2:1) are excluded.

According to the present invention, it is preferred that that in the inventive seed treated with a composition, said composition comprises the compound according to formula (I) in an amount in the range of from 1 to 20 weight-%, preferably in the range of from 2 to 15 weight-%, more preferably in the range of from 3 to 10 weight-%, more preferably in the range of from 4 to 8 weight %, more preferably in the range of from 4 to 7.5 weight-%, based on the total weight of the composition.

According to the present invention, it is further preferred that that in the inventive seed treated with a composition, the composition further comprises a binder.

Furthermore, it is preferred according to the present invention that in the inventive seed treated with a composition, the binder is selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, a gelatin, one or more lignosulfonates, and a mixture of two or more thereof, preferably selected from the group consisting of one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

Yet, it is preferred according to the present invention that in the inventive seed treated with a composition, the binder is present in the composition in an amount in the range of from 5 to 45 weight-%, preferably in the range of from 10 to 40 weight-%, more preferably in the range of from 10 to 40 weight-%, based on the total weight of the composition.

Furthermore, it is preferred according to the present invention that in the inventive seed treated with a composition, the composition further comprises an inorganic pigment.

According to the present invention, it is preferred that that in the inventive seed treated with a composition, the inorganic pigment is selected from the group consisting of one or more titanium dioxide, one or more calcium carbonate, one or more iron oxide, one or more polygorskite ((Mg,Al)₂Si₄O₁₀(OH)·4(H₂O)), magnesium oxide, one or more clay and a mixture of two or more thereof, wherein preferably the inorganic pigment is titanium dioxide.

According to the present invention, it is preferred that that the inventive seed treated with a composition, from 95 to 100 weight-%, preferably from 98 to 100 weight-%, more preferably from 99 to 100 weight-% of the composition consist of the compound of formula (I), the binder and the inorganic pigment.

The present invention further relates to a process for producing the seed surface composition according to the present invention comprising:
(i) providing the compound according to formula (I);
(ii) providing a mixture comprising the compound according to formula (I); and
(iii) subjecting the mixture provided according to (ii) to mechanical treatment.

According to the present invention, it is preferred that in the process according to (i), the compound of formula (I) is provided as a solid.

According to the present invention, it is preferred that in the mixture provided in (ii), the compound according to formula (I) is mixed with a solvent, preferably with a solvent selected from the group consisting of one or more water, one or more ethylene glycol, one or more propylene glycol, one or more diethylene glycol, one or more hexylene glycol one or more methanol, one or more ethanol, one or more propanol, one or more isopropanol, one or more butanol, and a mixture of two or more thereof, more preferably with water.

According to the present invention, it is preferred that in the mixture provided in (ii), the compound according to formula (I) is mixed with a binder, preferably with a binder selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, one or more gelatin, one or more lignosulfonates, and a mixture of two or more thereof, preferably selected from the group consisting of one or more polyvinyl acetate, one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

According to the present invention, it is preferred the mechanical treatment according to (iii) comprises, preferably is blending.

According to the present invention, it is preferred that said blending is carried out at a speed of revolution in the range of from 2000 to 3500 revolutions per min (rpm), preferably in the range of from 2500 to 3000 revolutions per min (rpm), more preferably in the range of from 2700 to 2800 revolutions per min (rpm).

According to the present invention, it is particularly preferred that the mechanical treatment according to (iii) is carried out for a duration in the range of from 0.2 to 8 min, preferably in the range of from 0.5 to 5 min, more preferably in the range of from 0.4 to 3 min.

The present invention further relates to a process comprising treating seeds with a seed surface composition according to any one of embodiments of the present invention comprising contacting a plurality of seeds with the seed surface composition according to any one of embodiments 1 to 19 in an amount in the range of from 0.2 to 2 weight-%, preferably in the range of from 0.4 to 1.5 weight-%, more preferably in the range of from 0.5 to 1 weight-%, based on the total weight of the seeds.

According to the present invention, it is preferred that said contacting comprises, preferably is spraying, wherein more preferably said spraying is carried out in a rotary mixer or in a fluid bed mixer, preferably at a temperature in the range from 15° C. to 30° C., preferably in the range from 20° C. to 25° C.

According to the present invention, it is preferred that said treating comprises dressing, coating and pelleting. According to the present invention seed dressing is a process of seed treatment.

In this process, seeds are mixed with a dry or wet composition either at a specialized seed treatment facility or at the farm site. The dressing does not completely cover the seed. According to the present invention seed coating represents a complete coating of the seed. According to the present invention seed pelleting results in changing the physical shape of a seed to enhance handling and plantability. Pelleting requires specialized application machinery.

The present invention further relates to a seed surface composition, preferably a seed surface composition as described in any of the particular and preferred embodiments described in the present description, obtainable or obtained by a process as described in any of the particular and preferred embodiments described in the present description.

The present invention further relates to a seed, preferably a seed as described in any of the particular and preferred embodiments described in the present description, obtainable or obtained by a process as described in any of the particular and preferred embodiments described in the present description.

The present invention further relates to the use of a compound according to formula (I)

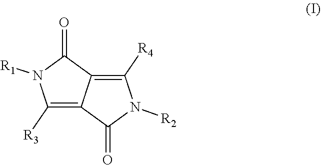

in a seed surface composition, wherein R₁ and R₂ may, independently of one another stand for hydrogen, C₁-C₄ alkyl, halogenated C₁-C₄ alkyl, C₁-C₄ acetyl; and R₃ and R₄ may, independently of one another stand for phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

According to a preferred embodiment, the present invention further relates to the use as described in the present description, wherein R₁ and R₂ may, independently of one another stand for hydrogen, C₁-C₄ alkyl, phenyl; and R₃ and R₄ may, independently of one another stand phenyl, C₁-C₅ alkyl phenyl, halogenated phenyl, cyanophenyl.

According to a particularly preferred embodiment, the present invention further relates to the use as described in the present description, wherein R₁ and R₂ are hydrogen; and R₃ and R₄ may, independently from one another, stand for phenyl, methylphenyl, 1,1-dimethylethylphenyl halogenated phenyl.

According to a preferred embodiment, the present invention further relates to the use as described in the present description, wherein R₁ is R₂ and R₃ is R₄.

According to a particularly preferred embodiment, the present invention further relates to the use as described in the present description, wherein R₁ and R₂ are hydrogen; and R₃ and R₄ are halogenated phenyl.

According to a preferred embodiment, the present invention further relates to the use as described in the present description, wherein R₁ and R₂ are hydrogen; and R₃ and R₄ are chlorophenyl.

According to said particular and preferred embodiments, the present invention further relates to the use as described in the present description, wherein R₁ and R₂ are hydrogen; and R₃ and R₄ are 4-chlorophenyl.

The present invention further relates to an agricultural, food and forage product comprising the seed as described in any of the particular and preferred embodiments described in the present description.

The present invention further relates to a seed surface composition as described in any of the particular and preferred embodiments described in the present description for use in one or more of an agricultural, food and forage product.

The present invention further relates to the use of a seed surface composition as described in any of the particular and preferred embodiments described in the present description as a component of one or more of an agricultural, food and forage product.

The present invention further relates to a seed as described in any of the particular and preferred embodiments described in the present description comprised in one or more of an agricultural, food and forage product.

The present invention further relates to a seed as described in any of the particular and preferred embodiments described in the present description for use as one or more of an agricultural, food and forage product.

The present invention further relates to the use of a seed as described in any of the particular and preferred embodiments described in the present description as a component of one or more of an agricultural, food and forage product.

The present invention is illustrated by the following set of embodiments and combinations of embodiments resulting from the dependencies and back-references as indicated. In particular, it is noted that in each instance where a range of embodiments is mentioned, for example in the context of a term such as “The seed surface composition of any one of embodiments 1 to 4”, every embodiment in this range is meant to be explicitly disclosed for the skilled person, i.e. the wording of this term is to be understood by the skilled person as being synonymous to “The seed surface composition of any one of embodiments 1, 2, 3 and 4”. Further, it is explicitly noted that the following set of embodiments is not the set of claims determining the extent of protection, but represents a suitably structured part of the description directed to general and preferred aspects of the present invention.

According to an embodiment (1), the present invention relates to a seed surface composition comprising a compound according to formula (I)

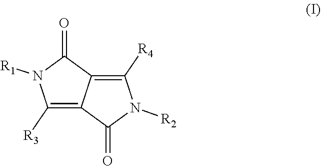

wherein R₁ and R₂ are independently of one another hydrogen, C₁-C₄ alkyl, halogenated C₁-C₄ alkyl, C₁-C₄ acetyl; and R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

A preferred embodiment (2) concretizing embodiment (1), wherein said seed is an embryonic plant enclosed in a protective outer covering, wherein preferably said seed is selected from the group consisting of one or more of a plant, fruit or vegetable seed, more preferably said seed is selected from the group consisting of one or more of cereal seed, grass seed, vegetable seed, forage seed, legume seed, oil plant seed and a mixture of two or more thereof.

A preferred embodiment (3) concretizing embodiment (1) or (2), wherein R₁ and R₂ are independently of one another hydrogen, C₁-C₄ alkyl; and R₃ and R₄ are independently of one another phenyl, C₁-C₅ alkylphenyl, halogenated phenyl, cyanophenyl.

A preferred embodiment (4) concretizing any one of embodiments (1) to (3), wherein R₁ and R₂ are independently of one another hydrogen, C₁-C₄ alkyl; and R₃ and R₄ are independently of one another phenyl, methylphenyl, 1,1-dimethylethyl phenyl, halogenated phenyl.

A preferred embodiment (5) concretizing any one of embodiments (1) to (4), wherein R₁ is R₂.

A preferred embodiment (6) concretizing any one of embodiments (1) to (5), wherein R₃ is R₄.

A preferred embodiment (7) concretizing any one of embodiments (1) to (6), wherein R₁ and R₂ are hydrogen; and R₃ and R₄ are halogenated phenyl.

A preferred embodiment (8) concretizing any one of embodiments (1) to (7), wherein R₁ and R₂ are hydrogen; and R₃ and R₄ are chlorophenyl.

A preferred embodiment (9) concretizing any one of embodiments (1) to (8), wherein R₁ and R₂ are hydrogen; and R₃ and R₄ are 4-chlorophenyl.

A preferred embodiment (10) concretizing any one of embodiments (1) to (9), with the proviso that in said composition diazo compounds, preferably 3-hydroxy-N-(2-methylphenyl)-4-[(2,4,5-trichlorophenyl)diazenyl]naphthalene-2-carboxamide, calcium 2-[(3-carboxy-2-oxidonaphthalen-1-yl)diazenyl]-4-chloro-5-methylbenzenesulfonate, disodium 2-[(3-carboxy-2-oxidonaphthalen-1-yl)diazenyl]-5-methylbenzenesulfonate, calcium 2-[(3-carboxy-2-oxidonaphthalen-1-yl)diazenyl]-5-methylbenzenesulfonate and 5-chloro-2-[(2-hydroxy-1-naphthalenyl)azo]-4-methyl benzene-sulfonic acid, barium salt (2:1) are excluded.

A preferred embodiment (11) concretizing any one of embodiments (1) to (10), wherein the compound (1) is present in an amount in a range of from 1 to 20 weight-%, preferably in the range of from 2 to 15 weight-%, more preferably in the range of from 3 to 10 weight-%, more preferably in the range of from 4 to 8 weight-%, more preferably in the range of from 4 to 7.5 weight-%, based on the total weight of the seed surface composition.

A preferred embodiment (12) concretizing any one of embodiments (1) to (11), wherein said seed surface composition further comprises a binder.

A preferred embodiment (13) concretizing embodiment (12), wherein the binder is selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, one or more gelatin, one or more lignosulfonates, and a mixture of two or more thereof, preferably selected from the group consisting of one or more polyvinyl acetate, one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

A preferred embodiment (14) concretizing embodiment (12) or (13), wherein the binder is present in the seed surface composition in an amount in the range of from 5 to 50 weight-%, preferably in the range of from 10 to 45 weight-%, more preferably in the range of from 10 to 40 weight-% based on the total weight of the seed surface composition.

A preferred embodiment (15) concretizing any one of embodiments (1) to (14), wherein said seed surface composition further comprises water.

A preferred embodiment (16) concretizing embodiment (15), wherein the water is present in the seed surface composition in an amount in the range of from 40 to 85 weight-%, preferably in the range of from 45 to 80 weight-%, more preferably in the range of from 50 to 75 weight-% based on the total weight of the seed surface composition.

A preferred embodiment (17) concretizing any one of embodiments (1) to (16), wherein said seed surface composition further comprises an inorganic pigment.

A preferred embodiment (18) concretizing embodiment (17), wherein the inorganic pigment is selected from the group consisting of one or more titanium dioxide, one or more calcium carbonate, one or more iron oxide, one or more polygorskite ((Mg,Al)₂Si₄O₁₀(OH)·4(H₂O)), magnesium oxide, one or more clay and a mixture of two or more thereof, preferably the inorganic pigment is titanium dioxide.

A preferred embodiment (19) concretizing any one of embodiments (1) to (18), wherein from 95 to 100 weight-%, preferably from 98 to 100 weight-%, more preferably from 99 to 100 weight-% of the composition consist of the compound of formula (I), the binder and the inorganic pigment.

According to an embodiment (20), the present invention relates to a seed treated with a composition, said composition comprising a compound according to formula (I)

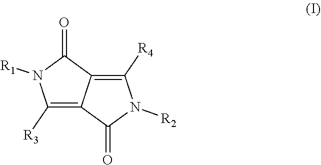

wherein R₁ and R₂ are independently of one another hydrogen, C₁-C₄ alkyl, halogenated C₁-C₄ alkyl, C₁-C₄ acetyl; and R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

A preferred embodiment (21) concretizing embodiment (20), wherein said seed is an embryonic plant enclosed in a protective outer covering, wherein preferably said seed is selected from the group consisting of one or more of a plant, fruit or vegetable seed, more preferably said seed is selected from the group consisting of one or more of cereal seed, grass seed, vegetable seed, forage seed, legume seed, oil plant seed and a mixture of two or more thereof.

A preferred embodiment (22) concretizing embodiment (20) or (21), wherein R₁ and R₂ are independently of one another hydrogen, C₁-C₄ alkyl; and R₃ and R₄ are independently of one another phenyl, C₁-C₅ alkyl phenyl, halogenated phenyl, cyanophenyl.

A preferred embodiment (23) concretizing any one of embodiments (20) to (22), wherein R₁ and R₂ are hydrogen; and R₃ and R₄ are independently of one another phenyl, methylphenyl, 1,1-methylethylphenyl, halogenated phenyl.

A preferred embodiment (24) concretizing any one of embodiments (20) to (23), wherein R₁ is R₂.

A preferred embodiment (25) concretizing any one of embodiments (20) to (24), wherein R₃ is R₄.

A preferred embodiment (26) concretizing any one of embodiments (20) to (25), wherein R₁ and R₂ are hydrogen; and R₃ and R₄ are halogenated phenyl.

A preferred embodiment (27) concretizing any one of embodiments (20) to (26), wherein R₁ and R₂ are hydrogen; and R₃ and R₄ are chlorophenyl.

A preferred embodiment (28) concretizing any one of embodiments (20) to (27), wherein R₁ and R₂ are hydrogen; and R₃ and R₄ are 4-chlorophenyl.

A preferred embodiment (29) concretizing any one of embodiments (20) to (28), with the proviso that in said seed treated with a composition diazo compounds, preferably 3-hydroxy-N-(2-methylphenyl)-4-[(2,4,5-trichlorophenyl)diazenyl]naphthalene-2-carboxamide, calcium 2-[(3-carboxy-2-oxidonaphthalen-1-yl)diazenyl]-4-chloro-5-methylbenzenesulfonate, disodium 2-[(3-carboxy-2-oxidonaphthalen-1-yl)diazenyl]-5-methylbenzenesulfonate, calcium 2-[(3-carboxy-2-oxidonaphthalen-1-yl)diazenyl]-5-methylbenzenesulfonate and 5-chloro-2-[(2-hydroxy-1-naphthalenyl)azo]-4-methyl benzene sulfonic acid, barium salt (2:1) are excluded.

A preferred embodiment (30) concretizing any one of embodiments (20) to (29), wherein the composition comprises the compound according to formula (I) in an amount in the range of from 1 to 20 weight-%, preferably in the range of from 2 to 15 weight-%, more preferably in the range of from 3 to 10 weight-%, more preferably in the range of from 4 to 8 weight-%, more preferably in the range of from 4 to 7.5 weight-%, based on the total weight of the composition.

A preferred embodiment (31) concretizing any one of embodiments (20) to (30), wherein the composition further comprises a binder.

A preferred embodiment (32) concretizing embodiment (31), wherein the binder is selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, a gelatin, one or more lignosulfonates, and a mixture of two or more thereof, preferably selected from the group consisting of one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

A preferred embodiment (33) concretizing embodiment (31) or (32), wherein the binder is present in the composition in an amount in the range of from 5 to 45 weight-%, preferably in the range of from 10 to 40 weight-%, more preferably in the range of from 10 to 40 weight-%, based on the total weight of the composition.

A preferred embodiment (34) concretizing any one of embodiments (20) to (33), wherein the composition further comprises an inorganic pigment.

A preferred embodiment (35) concretizing embodiment (34), wherein the inorganic pigment is selected from the group consisting of one or more titanium dioxide, one or more calcium carbonate, one or more iron oxide, one or more polygorskite ((Mg,Al)₂Si₄O₁₀(OH)·4(H₂O)), magnesium oxide, one or more clay and a mixture of two or more thereof, wherein preferably the inorganic pigment is titanium dioxide.

A preferred embodiment (36) concretizing any one of embodiments (20) to (35), wherein from 95 to 100 weight-%, preferably from 98 to 100 weight-%, more preferably from 99 to 100 weight % of the composition consist of the compound of formula (I), the binder and the inorganic pigment.

According to an embodiment (37), the present invention relates to a process for producing the seed surface composition according to any one of embodiments (1) to (19), comprising:
(i) providing the compound according to formula (I);
(ii) providing a mixture comprising the compound according to formula (I); and (iii) subjecting the mixture provided according to (ii) to mechanical treatment.

A preferred embodiment (38) concretizing embodiment (37), wherein according to (i), the compound of formula (I) is provided as a solid.

A preferred embodiment (39) concretizing embodiment (37) or (38), wherein according to (ii), the compound according to formula (I) is mixed with a solvent, preferably with a solvent selected from the group consisting of one or more water, one or more ethylene glycol, one or more propylene glycol, one or more diethylene glycol, one or more hexylene glycol one or more methanol, one or more ethanol, one or more propanol, one or more isopropanol, one or more butanol, and a mixture of two or more thereof, more preferably with water.

A preferred embodiment (40) concretizing any one of embodiments (37) to (39), wherein according to (ii), the compound according to formula (I) is mixed with a binder, preferably with a binder selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, one or more gelatin, one or more lignosulfonates, and a mixture of two or more thereof, preferably selected from the group consisting of one or more polyvinyl acetate, one or more polyalkylene glycol, one or more poly(acrylic acid), and a mixture of two or more thereof, more preferably selected from the group consisting of one or more polyvinyl acetate, one or more polyethylene glycol, one or more poly(acrylic acid), and a mixture of two or more thereof.

A preferred embodiment (41) concretizing any one of embodiments (37) to (40), wherein the mechanical treatment according to (iii) comprises, preferably is blending.

A preferred embodiment (42) concretizing any one of embodiments (37) to (41), wherein said blending is carried out at a speed of revolution in the range of from 2000 to 3500 revolutions per min (rpm), preferably in the range of from 2500 to 3000 revolutions per min (rpm), more preferably in the range of from 2700 to 2800 revolutions per min (rpm).

A preferred embodiment (43) concretizing any one of embodiments (37) to (42), wherein the mechanical treatment according to (iii) is carried out for a duration in the range of from 0.2 to 8 min, preferably in the range of from 0.5 to 5 min, more preferably in the range of from 0.4 to 3 min.

According to an embodiment (44), the present invention relates to a process comprising treating seeds with a seed surface composition according to any one of embodiments 1 to 19 comprising contacting a plurality of seeds with the seed surface composition according to any one of embodiments 1 to 19 in an amount in the range of from 0.2 to 2 weight-%, preferably in the range of from 0.4 to 1.5 weight-%, more preferably in the range of from 0.5 to 1 weight-%, based on the total weight of the seeds.

A preferred embodiment (45) concretizing embodiment (44), wherein said contacting comprises, preferably is spraying, wherein more preferably said spraying is carried out in a rotary mixer or in a fluid bed mixer, preferably at a temperature in the range from 15° C. to 30° C., preferably in the range from 20° C. to 25° C.

A preferred embodiment (46) concretizing embodiment (44) or (45) wherein said treating comprises dressing, coating and pelleting. Seed dressing is a process of seed treatment. In this process, the seeds are mixed with a dry or wet composition either at a specialized seed treatment facility or at the farm site. The dressing does not completely cover the seed. Seed coating represents a complete coating of the seed. Seed pelleting results in changing the physical shape of a seed to enhance handling and plantability. Pelleting requires specialized application machinery.

According to an embodiment (47), the present invention relates to a seed surface composition, preferably a seed surface composition according to any one of embodiments (1) to (19), obtainable or obtained by a process according to any one of embodiments (37) to (43).

According to an embodiment (48), the present invention relates to a seed, preferably a seed according to any one of embodiments (20) to (36), obtainable or obtained by a process according to any one of embodiments (44) to (46).

According to an embodiment (49), the present invention relates to the use of a compound according to formula (I)

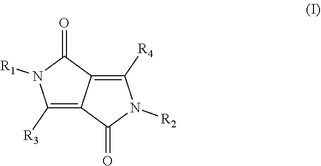

in a seed surface composition, wherein R₁ and R₂ are independently of one another hydrogen, C₁-C₄ alkyl, halogenated C₁-C₄ alkyl, C₁-C₄ acetyl; and R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

A preferred embodiment (50) concretizing embodiment (49), wherein R₁ and R₂ are independently of one another hydrogen, C₁-C₄ alkyl, phenyl; and R₃ and R₄ are independently of one another phenyl, C₁-C₅ alkyl phenyl, halogenated phenyl, cyanophenyl.

A preferred embodiment (51) concretizing embodiment (49) or (50), wherein R₁ and R₂ are hydrogen; and R₃ and R₄ are independently of one another phenyl, methylphenyl, 1,1-dimethylethylphenyl halogenated phenyl.

A preferred embodiment (52) concretizing any one of embodiments (49) to (51), wherein R₁ is R₂.

A preferred embodiment (53) concretizing any one of embodiments (49) to (52), wherein R₃ is R₄.

A preferred embodiment (54) concretizing any one of embodiments (49) to (53), wherein R₁ and R₂ are hydrogen; and R₃ and R₄ are halogenated phenyl.

A preferred embodiment (55) concretizing any one of embodiments (49) to (54), wherein R₁ and R₂ are hydrogen; and R₃ and R₄ are chlorophenyl.

A preferred embodiment (56) concretizing any one of embodiments (49) to (55), wherein R₁ and R₂ are hydrogen; and R₃ and R₄ are 4-chlorophenyl.

A preferred embodiment (57) concretizing any one of embodiments (49) to (56), wherein said seed is an embryonic plant enclosed in a protective outer covering, wherein preferably said seed is selected from the group consisting of one or more of a plant, fruit or vegetable seed, more preferably said seed is selected from the group consisting of one or more of cereal seed, grass seed, vegetable seed, forage seed, legume seed, oil plant seed and a mixture of two or more thereof.

According to an embodiment (58), the present invention relates to an agricultural, food and forage product comprising the seed according to any one of embodiments (20) to (36) or (48).

According to an embodiment (59), the present invention relates to a seed surface composition according to any one of embodiments (1) to (19) or (47) for use in one or more of an agricultural, food and forage product.

According to an embodiment (60), the present invention relates to the use of a seed surface composition according to any one of embodiments (1) to (19) or (47) as a component of one or more of an agricultural, food and forage product.

According to an embodiment (61), the present invention relates to a seed according to any one of embodiments (20) to (36) or (48) comprised in one or more of an agricultural, food and forage product.

According to an embodiment (62), the present invention relates to a seed according to any one of embodiments (20) to (36) or (48) for use as one or more of an agricultural, food and forage product.

According to an embodiment (63), the present invention relates to the use of a seed according to any one of embodiments (20) to (36) or (48) as a component of one or more of an agricultural, food and forage product.

The present invention is further illustrated by the following Examples and Reference Examples.

### Reference Examples: Determination Methods

a) L*a*b* C* Determination

The term L * (lightness) used herein means the lightness in the L*a*b* color space (also referred to as CIELAB) specified by the Commission Internationale de l'Eclairage, wherein a* and b* are the chromaticity coordinates. The L* value is measured at an observation angle of 25°. According to the CIELAB system, L*=100 means the lightest value (white), L*=0 means the darkest value (black). Generally, a L* value refers to an opaque coating.

The term C* (chrome) used herein means the chroma in the L*C*h color space (also referred to as CIELAB) specified by the Commission Internationale de l'Eclairage, wherein L* is the same lightness as in the L*a*b* color space and h is the hue angle.

Solid colors (CIELAB color measurement) were measured using Datacolor 650 d8 integrating sphere spectrophotometer with D65 illuminant and 10° observer. Data handling via BASF ColorCare software.

b) Color Quality Scale

The color quality scale has been determined visually. The value 1 refers to a color that is barely viewable. The value 2 refers to a color that sticks less than 50% to the surface of the seed. The value 3 refers to a color that sticks more than 50% but irregularly to the surface of the seed. The value 4 refers to an almost completely colored surface of the seed. The value 5 refers to completely and perfectly colored surface of the seed.

### EXAMPLES

### Example 1

The compound according to the formula I (Compound 1: C.I. Pigment Red (PR) 254 (3,6-bis(4-chlorophenyl)-2,5-dihydropyrrolo[3,4-c]pyrrole-1,4-dione)) was mixed with a binder and water in a speed mixer at 2750 min⁻¹ (rpm) for 1 minute to obtain a seed surface composition. The ingredients and amounts used in Example 1 are listed in Table 1. 0.5 g of the obtained seed surface composition was sprayed on 100 g corn seeds.

### Examples 2 to 4

Examples 2 to 4 were prepared according to Example 1 with the ingredients and amounts listed in Table 5.

### Comparative Example 1

Comparative Compound 1 (C.I. Pigment Red (PR) 112 (4-[(2,5-dichlorophenyl)azo]-3-hydroxy-2-naphtho-o-toluidide) was mixed with a binder and water in a speed mixer at 2750 min⁻¹ (rpm) for 1 minute to obtain a seed surface composition. The ingredients and amounts used in Comparative Example 1 are listed in Table 1. 1 g of the obtained seed surface composition was sprayed on 100 g corn seeds.

### Comparative Examples 2 to 4

Comparative Examples 2 to 4 were prepared according to Comparative Example 1 with the ingredients and amounts listed in Table 1.

TABLE 1
Seed surface compositions according to Examples 1
to 4 and Comparative Examples 1 to 4 in weight-%

| | Comp. | | Comp. | | Comp. | | Comp | |
|---|---|---|---|---|---|---|---|---|
| | Ex. 1 | Ex.1 | Ex. 2 | Ex. 2 | Ex. 3 | Ex. 3 | Ex. 4 | Ex. 4 |
| Comp. Compound 1 | 15 | | 10 | — | 10 | — | 10 | — |
| Compound 1 | — | 7.5 | — | 5 | — | 5 | — | 5 |
| ¹Pluriol ® E 400 | 10 | 10 | — | — | — | — | — | 1 |
| ²Joncryl ® 678 | — | — | 40 | 40 | — | — | — | — |
| ³Joncryl ® 1532 | — | — | — | — | 40 | 40 | — | — |
| ⁴Polyselect ® 500 | — | — | — | — | — | — | 40 | 40 |
| Water | 75 | 75 | 50 | 55 | 50 | 55 | 50 | 55 |

¹Pluriol ® E 400 is a binder that comprises polyethylene glycol. ¹Pluriol E 400 is commercially available from BASF.
²Joncryl ® 678 is a binder that comprises modified styrene acrylic polymers. Joncryl ® 678 is commercially available from BASF.
³Joncryl ® 1532 is a binder that comprises ammonium salt of modified acrylic copolymers. Joncryl ® 1532 is commercially available from BASF.
⁴Polyselect ® 500 is a binder that comprises polyvinyl acetate. Polyselect ® 500 is commercially available from Germains.

TABLE 2
Spin coloristic data [spin(0.04) d8] of a seed surface composition
according to Example 1 comprising the compound 1

| Compound 1 | h | C* | L* | a* | b* |
|---|---|---|---|---|---|
| 7.5 weight-% | 43.19 | 69.51 | 28.5 | 50.68 | 47.57 |
| 15 weight-% | 42.12 | 69.26 | 27.85 | 51.37 | 46.45 |
| 15 weight-% | 40.27 | 65.97 | 25.64 | 50.34 | 42.64 |

TABLE 3
Spex coloristic data [spex(0.00) d8] of a seed surface composition
according to Example 1 comprising the compound 1

| Compound 1 | h | C* | L* | a* | b* |
|---|---|---|---|---|---|
| 7.5 weight-% | 36.97 | 48.19 | 36.96 | 38.5 | 28.98 |
| 10 weight-% | 36.75 | 49.39 | 36.19 | 39.57 | 29.55 |
| 15 weight-% | 37.52 | 49.27 | 34.05 | 39.08 | 30 |

TABLE 4
Spin coloristic data [spin(0.04) d8] of a seed
surface composition according to Comparative Example
1 comprising the comparative compound 1

| Comparative | | | | | |
|---|---|---|---|---|---|
| compound 1 | h | C* | L* | a* | b* |
| 7.5 weight-% | 49.58 | 71.1 | 32.93 | 46.1 | 54.12 |
| 10 weight-% | 47.61 | 71.26 | 31.48 | 48.04 | 52.63 |
| 15 weight-% | 43.5 | 70.22 | 28.94 | 50.93 | 48.34 |

TABLE 5
Spex coloristic data [spex(0.00) d8] of a seed
surface composition according to Comparative Example
1 comprising the comparative compound 1

| Comparative | | | | | |
|---|---|---|---|---|---|
| compound 1 | h | C* | L* | a* | b* |
| 7.5 weight-% | 38.26 | 46.63 | 40.43 | 36.61 | 28.88 |
| 10 weight-% | 38.44 | 47.91 | 39.27 | 37.52 | 29.78 |
| 15 weight-% | 37.77 | 51.25 | 36.73 | 40.51 | 31.39 |

TABLE 6
Comparison of L*, a* and b* values of a seed surface
composition comprising 7.5 weight-% of the compound
1 (Example 1) and 15 weight-% of the comparative
compound 1 (Comparative Example 1)

| | spin(0.04) d8 | | | spex(0.00) d8 | | |
|---|---|---|---|---|---|---|
| | L* | a* | b* | L* | a* | b* |
| Example 1 | 28.5 | 50.68 | 47.57 | 36.96 | 38.5 | 28.98 |
| Comp. Example 1 | 28.94 | 50.93 | 48.34 | 36.73 | 40.51 | 31.39 |

Table 6 shows a comparison of L*, a* and b* values of a surface formulation comprising 7.5 weight-% of the compound 1 and 15 weight-% of the diazo pigment (comparative compound 1). As can be taken from Table 6, with a half load of the compound 1, the same color depth compared to the diazo pigment (comparative compound 1) with a double load can be achieved.

TABLE 7
Comparison of the color quality of the composition comprising 5 or 7.5 weight-%
of the compound 1 and 10 or 15 weight-% of the comparative compound 1

| | Comp. | | Comp. | | Comp. | | Comp. | |
|---|---|---|---|---|---|---|---|---|
| | Ex. 1 | Ex.1 | Ex. 2 | Ex. 2 | Ex. 3 | Ex. 3 | Ex. 4 | Ex. 4 |
| Comp. Compound 1 | 15 | | 10 | — | 10 | — | 10 | — |
| Compound 1 | — | 7.5 | — | 5 | — | 5 | — | 5 |
| Color quality | 2 | 5 | 2 | 5 | 2 | 5 | 2 | 5 |

¹ Color is barely viewable on the surface of the seed
² Color sticks less than 50% on the surface of the seed
³ Color sticks more than 50% but irregularly on the surface of the seed
⁴Almost completely colored surface of the seed
⁵Complete and perfectly colored surface of the seed

Table 7 shows a comparison of the color quality of a composition comprising 7.5 weight-% (Example 1) or 5 weight-% (Examples 2-4) of the compound 1 and 15 weight-% (Comparative Example 1) or 10 weight-% (Comparative Examples 2-4) of the diazo pigment (comparative compound 1). As can be taken from Table 7, the seed surface composition comprising 7.5 weight-% (Example 1) or 5 weight-% (Examples 2-4) of the compound 1 has good opacity, shade, adhesion and uniformity of the color (value 5) compared to the composition comprising 15 weight-% or 10 weight-% (Comparative Examples 2-4) of the diazo pigment (comparative compound 1) (value 2) even though only half of quantity of the compound 1 was used.

1. A seed surface composition comprising a compound according to formula (I) 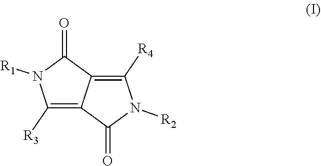
wherein
R₁ and R₂ are independently of one another hydrogen, C₁-C₄ alkyl, halogenated C₁-C₄ alkyl, C₁-C₄ acetyl; and
R₃ and R₄ are independently of one another phenyl, C₁-C₅ alkylphenyl, C₁-C₅ alkoxyphenyl, halogenated phenyl, cyanophenyl, biphenyl, halogenated biphenyl, pyridyl, C₁-C₅ alkylpyridyl, C₁-C₅ alkoxypyridyl, halogenated pyridyl or naphthyl.

2. The seed surface composition of claim 1, wherein
R₁ and R₂ are independently of one another hydrogen, C₁-C₄ alkyl; and
R₃ and R₄ are independently of one another phenyl, C₁-C₅ alkylphenyl, halogenated phenyl, cyanophenyl.

3. The seed surface composition of claim 1, wherein
R₁ and R₂ are independently of one another hydrogen, C₁-C₄ alkyl; and
R₃ and R₄ are independently of one another phenyl, methylphenyl, 1,1-dimethylethylphenyl, halogenated phenyl.

4. The seed surface composition of claim 1, wherein
R₁ and R₂ are hydrogen; and
R₃ and R₄ are 4-chlorophenyl.

5. The seed surface composition of claim 1, wherein said seed surface composition further comprises a binder.

6. A seed treated with a composition, said composition comprising a compound according to formula (I) 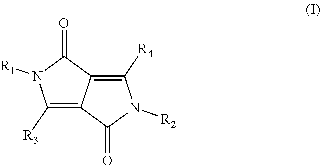
wherein
R₁ and R₂ are independently of one another hydrogen, C₁-C₄ alkyl, halogenated C₁-C₄ alkyl, C₁-C₄ acetyl; and
R₃ and R₄ are independently of one another phenyl, C₁-C₅ alkylphenyl, C₁-C₅ alkoxyphenyl, halogenated phenyl, cyano phenyl, biphenyl, halogenated biphenyl, pyridyl, C₁-C₅ alkylpyridyl, C₁-C₅ alkoxypyridyl, halogenated pyridyl or naphthyl.

7. A process for producing the seed surface composition according to claim 1, comprising:
(i) providing the compound according to formula (I);
(ii) providing a mixture comprising the compound according to formula (I); and
(iii) subjecting the mixture provided according to (ii) to mechanical treatment.

8. The process of claim 7, wherein according to (i), the compound of formula (I) is provided as a solid.

9. The process of claim 7 wherein according to (ii), the compound according to formula (I) is mixed with a solvent.

10. The process of claim 7, wherein according to (ii), the compound according to formula (I) is mixed with a binder.

11. The process of claim 7, wherein the mechanical treatment according to (iii) comprises blending.

12. A process comprising treating seeds with a seed surface composition, comprising contacting a plurality of seeds with the seed surface composition according to claim 1 in an amount in the range of from 0.2 to 2 weight % based on the total weight of the seeds.

13. (canceled)

14. (canceled)

15. An agricultural, food and forage product comprising the seed according to claim 6.

16. The seed surface composition of claim 3, wherein the halogenated phenyl is chlorophenyl.

17. The process of claim 9, wherein the solvent is selected from the group consisting of one or more water, one or more ethylene glycol, one or more propylene glycol, one or more diethylene glycol, one or more hexylene glycol one or more methanol, one or more ethanol, one or more propanol, one or more isopropanol, one or more butanol, and a mixture of two or more thereof.

18. The process of claim 17, wherein the solvent is water.

19. The process of claim 10, wherein the binder is selected from the group consisting of one or more polyvinyl acetate, one or more polyalkylene glycol, one or more poly(vinyl alcohol), one or more carboxymethylcellulose, one or more hydroxyethylcellulose, one or more poly(acrylic acid), one or more polyacrylamide, one or more gelatin, one or more lignosulfonates, and a mixture of two or more thereof.

20. The process of claim 10, wherein the binder is selected from the group consisting of one or more polyvinyl acetate, one or more polyalkylene glycol, one or more poly(acrylic acid), and a mixture of two or more thereof.

21. The process of claim 20, wherein the binder is selected from the group consisting of one or more polyvinyl acetate, one or more polyethylene glycol, one or more poly(acrylic acid), and a mixture of two or more thereof.

22. The process of claim 12, wherein the amount of the seed surface composition is in the range of from 0.4 to 1.5 weight %, based on the total weight of the seeds.

23. The process of claim 12, wherein the amount of the seed surface composition is in the range of from 0.5 to 1 weight %, based on the total weight of the seeds.
